(19) United States
(12) Patent Application Publication
(10) Pub. No.: US 2010/0102762 A1
(43) Pub. Date: Apr. 29, 2010

(54) POWER CONVERTER

(75) Inventors: Shiro Sugimoto, Takasago-shi, Hyogo (JP); Hiroshi Kawashima, Takasago-shi, Hyogo (JP)

Correspondence Address: KANESAKA BERNER AND PARTNERS LLP, 1700 DIAGONAL RD, SUITE 310, ALEXANDRIA, VA, 22314-2848, US

(73) Assignee: MITSUBISHI HEAVY INDUSTRIES, LTD., Tokyo (JP)

(21) Appl. No.: 12/593,460

(22) PCT Filed: Oct. 20, 2008
(86) PCT No.: PCT/JP2008/068976

§ 371 Date: Nov. 15, 2009

(30) Foreign Application Priority Data
Oct. 23, 2007 (JP) 2007-275707

(51) Int. Cl. H02P 3/14; H02M 7/49; H02M 5/45

(52) U.S. Cl. 318/376; 363/71; 363/37

(57) ABSTRACT

An object of the invention is to provide a power converter that is capable of easily constituting a bidirectional power conversion system, and that can realize power regeneration. In a power converter in which cell power modules U1 to U4, V1 to V4, and W1 to W4 comprising single-phase inverters 4A and 4B are serially connected for each phase, and in which three phases are provided, and which converts and outputs power that is input from a power source, isolation transformers are provided between each cell power module U1 to U4, V1 to V4, and W1 to W4 and the power source side, or between each cell power module U1 to U4, V1 to V4, and W1 to W4 and the output side.

### TECHNICAL FIELD

The present invention relates to a power converter such as a multicell inverter.

### BACKGROUND ART

A multicell inverter is a multi-series inverter in which a large number of low-voltage single-phase inverters called “cell inverters” are connected in series, and further, are combined in a three-phase star shape that is centered on a neutral point, and between the vertices thereof, the multicell inverter can directly obtain a predetermined high voltage and large-capacity output.

The output voltage of a cell inverter can be selected at a low voltage of approximately 450 to 650V according to the withstand voltage of a general-purpose IGBT element. In general, irrespective of the output capacity, the total number of cell inverters comprising a multicell inverter is between 9 and 12 when the output voltage of the multicell inverter is 3.3 kV, and is between 18 and 24 when the output voltage is 6.6 kV. When the total number of cell inverters is large, the output per cell inverter lessens to between 280 to 370 kVA, even in a case in which the output voltage of the multicell inverter is 6600V.

The multicell inverter is a device that constitutes a high-voltage, large capacity converter by serially connecting a plurality of single-phase inverters for each phase and disposing these in a three-phase arrangement. A feature of a multicell inverter is that although the number of elements is large, with respect to the specifications of the element units, power conversion of a high voltage and a large capacity can be implemented without an output transformer. Another feature is that, by an equivalent switching carrier increase produced by multi-leveling of output voltages and serial connections, switching carriers can be reduced for each cell and a highly efficient power converter with low harmonics can be constructed.

Patent Document 1: Japanese Patent Laid-Open No. 2007-37290

### DISCLOSURE OF THE INVENTION

### Problems to be Solved by the Invention

However, in a multicell power conversion apparatus that can be combined with an electric motor according to a variable speed specification, a power source input side is configured as a polyphase rectifier circuit that is based on a three-phase rectification by a rectifier comprising a diode. Therefore, power source regeneration cannot be performed, and a braking operation can not be implemented.

Further, although a case in which power source regeneration is carried out by performing a converter operation using a switching element instead of a rectifier may be considered, in this case there is the problem that it is necessary to provide elements comprising three-phase converters for the amount of cell units, and therefore the number of elements increases and leads to a complicated configuration and higher costs.

In addition, because outputs on the output side of the converter are synthesized in parallel, it is difficult to execute electric power balance control for each cell for the purpose of evenly maintaining a direct-current intermediate voltage of each cell, and therefore it is also necessary to install a balancing reactor in each cell.

The present invention has been made in consideration of the above described circumstances, and an object of the invention is to provide a power converter that can easily comprise a bidirectional power conversion system, and that can realize power source regeneration.

### Means for Solving the Problems

To achieve the aforementioned object, the present invention provides a three-phase power converter, wherein a cell power module comprises a set of two single-phase inverters, and N (N being an integer) units of the cell power modules are serially connected to form each phase of the three-phases; and the power converter converts and outputs an electric power that is input from a power source.

In such a power converter, an electric power that is input from a power source side is subjected to power conversion by the cell power modules so that an electric motor provided on an output side is driven, and furthermore, when an electric power is generated at the electric motor, the electric power is subjected to power conversion by the cell power module and regenerated on the power source side.

By also providing a single-phase inverter for the power source side as in the present configuration, it is possible to send electric power not just from the power source side to the output side, but also from the output side to the power source side, and thus bidirectional power conversion is realized in which both input and output are provided with a multicell connection. That is, power source regeneration is enabled, and it is thereby possible to make full use of a braking force.

Preferably, such a power converter comprises an isolation transformer between each cell power module and a power source, or between each cell power module and an output side.

By adopting a configuration comprising isolation transformers, interference (sneaking) between cells at a time of power source regeneration or the like can be prevented. It is also possible to reduce harmonics. Furthermore, by varying the primary to secondary turns ratios of the isolation transformers, the voltage of the power converter can be set to an optimal value. An isolation transformer may be provided for each cell power module, or may be provided en bloc for all the cell power modules, for example, by using a five-legged core three-phase transformer.

Although an isolation transformer may be provided between each cell power module and the power source, or between each cell power module and the output side, of these it is preferable to provide an isolation transformer between each cell power module and the power source. By providing the isolation transformers on the power source side it is possible to suppress influences from the installation environment, such as a lightning surge.

A configuration may also be adopted in which an energy storage is provided in a direct current section of a single-phase inverter of a cell power module, and an electric power that is input from a power generator as a power source is subjected to power conversion by the cell power module, so that output fluctuations of the power generator are smoothed by charging and discharging of power by the energy storage.

Preferably, such a power converter also comprises a control section that performs control that adjusts so that an electric power supply that is demanded by an electric motor or electric power regeneration to the power source side is performed at a single-phase inverter on the electric motor side, and a direct-current voltage that is supplied to the cell power module is maintained at a target value at a single-phase inverter on the power source side.

### Advantages of the Invention

According to the power converter of the present invention, by providing a set of two single-phase inverters provided on a power source side and an output side, respectively, it is possible to send electric power not only from the power source side to the output side, but also from the output side to the power source side. As a result, bidirectional power conversion is realized in which both input and output are provided with a multicell connection. It is thereby possible to perform power source regeneration, and to make full use of a braking force.

Further, by providing an isolation transformer, interference (sneaking) between cells can be prevented, and a single-phase inverter can also be provided on the power source side. Accordingly, a bidirectional multicell power converter can be easily realized.

### BRIEF DESCRIPTION OF THE DRAWINGS

FIG. 1 is a circuit configuration diagram that illustrates a first embodiment of a power converter according to the embodiments;

FIG. 2 is a view that illustrates a single cell of the power converter according to the first embodiment;

FIG. 3 is a view that illustrates a change in state when the power converter according to the first embodiment is operated; and

FIG. 4 is a circuit configuration diagram that illustrates a second embodiment of a power converter according to the present invention.

### DESCRIPTION OF SYMBOLS

1 . . . power converter, 3 . . . isolation transformer, 4A, 4B . . . single-phase inverter, 7 . . . electric motor, 10 . . . energy storage, 20 . . . control apparatus, 30 . . . cell controller, U1 to U4, V1 to V4, W1 to W4 . . . cell power module

### BEST MODE FOR CARRYING OUT THE INVENTION

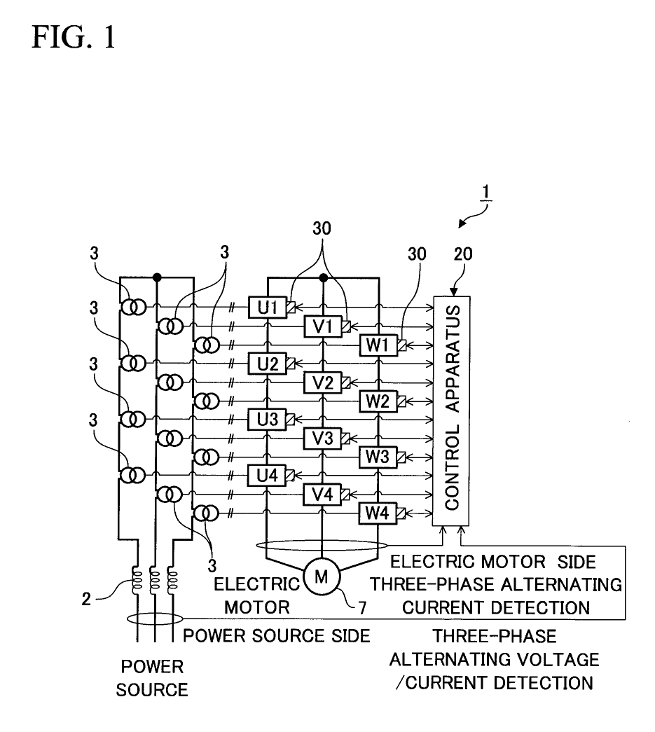

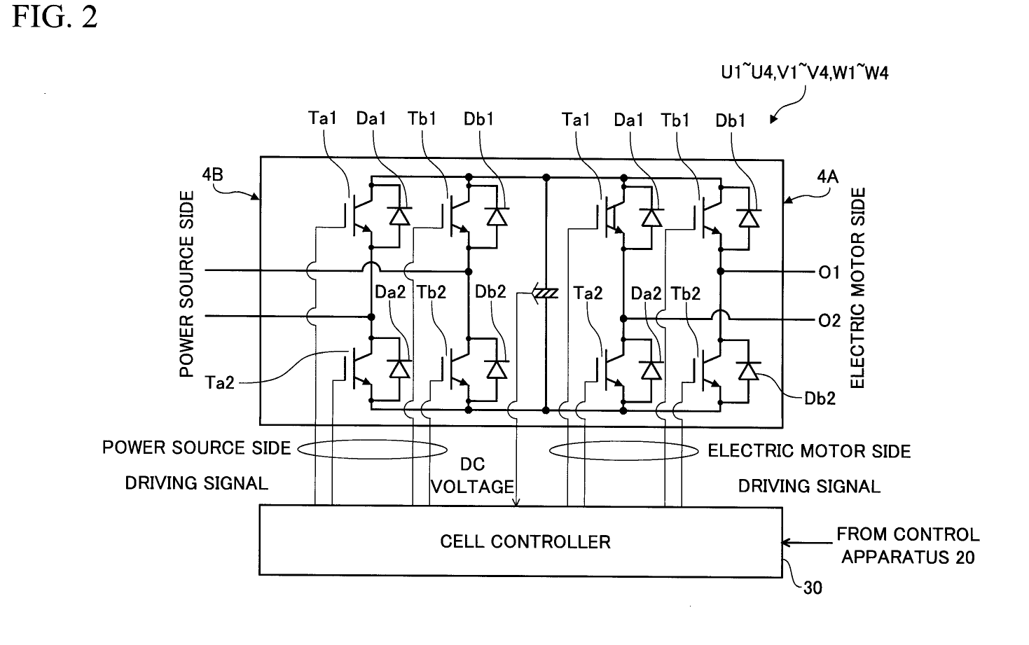

Next, a first embodiment of the present invention is described with reference to the drawings. FIG. 1 is a block diagram that shows the overall configuration of a power converter according to the present embodiment. FIG. 2 is a block diagram that schematically shows connections of one cell portion of the power converter according to the present embodiment.

As shown in FIG. 1, a power converter 1 of the present embodiment is an example of a twelve-cell configuration in which a U-phase, a V-phase, and a W-phase are connected with a Y-connection so that a phase difference is 120 degrees. The U-phase, V-phase, and W-phase are comprised by a plurality (according to the present embodiment, for example, four) of cell power modules U1 to U4, V1 to V4, and W1 to W4 that are connected in series, respectively. More specifically, the cell power modules U1, V1, and W1 are each connected with a neutral point, the cell power modules U1 to U4, V1 to V4, and W1 to W4 are serially connected, respectively, and the cell power modules U4, V4, and W4 are connected to an electric motor side.

Single-phase isolation transformers 3 are respectively connected to each cell. Each cell is serially connected at the outlet side of each isolation transformer 3 to form a multicell structure. The multicell structure is connected to a power source through an interconnecting reactor 2.

As shown in FIG. 2, the cell power modules U1 to U4, V1 to V4, and W1 to W4 each comprise a single-phase inverter 4A on an output side and a single-phase inverter 4B on a power source side. Further, because an isolation transformer 3 that perform both an isolation and a voltage adjustment function is provided in each of the cell power modules U1 to U4, V1 to V4, and W1 to W4, a bidirectional power converter is constructed in which both an electric motor side and a power source side have a multicell configuration.

The single-phase inverter 4A on the output side comprises IGBT elements Ta1 and Tb1 to which a collector is connected on the power source side, IGBT elements Ta2 and Tb2 to which an emitter is connected on the power source side, diodes Da1 and Db1 to which a cathode is connected on the power source side, and diodes Da2 and Db2 to which an anode is connected on the power source side. In the single-phase inverter 4A, an emitter of the IGBT element Ta1 and a collector of the IGBT element Ta2 as well as an anode of the diode Da1 and a cathode of the diode Da2 are connected to form one output terminal O1, and an emitter of the IGBT element Tb1 and a collector of the IGBT element Tb2 as well as an anode of the diode Db1 and a cathode of the diode Db2 are connected to form another output terminal O2.

The single-phase inverter 4B on the power source side is similarly configured. Hereunder, components of the single-phase inverter 4B that are the same as in the single-phase inverter 4A are denoted by the same reference symbols, and a description of those components is omitted. The single-phase inverter 4B differs from the single-phase inverter 4A in that, as shown in FIG. 1, isolation transformers 3 are connected between the emitter of the IGBT element Ta1 and the collector of the IGBT element Ta2 as well as the anode of the diode Da1 and the cathode of the diode Da2, and also between the emitter of the IGBT element Tb1 and the collector of the IGBT element Tb2 as well as the anode of the diode Db1 and the cathode of the diode Db2.

In the power converter 1 of the present embodiment configured in this manner, based on a command from a control apparatus 20 that controls the entire power converter 1, a cell controller 30 that is provided in each of the cell power modules U1 to U4, V1 to V4, and W1 to W4 controls operations of the single-phase inverters 4A and 4B.

More specifically, in the cell power modules U1 to U4, V1 to V4, and W1 to W4, by controlling driving signals that are provided to respective gates of the IGBT elements Ta1, Ta2, Tb1, and Tb2 of the single-phase inverter 4A on the electric motor 7 side by means of the cell controller 30, the control apparatus 20 outputs electric power of a single-phase alternating current to supply an electric power for performing electric motor control (acceleration, deceleration, a constant speed or the like) or to implement electric power regeneration to the power source side.

Further, in the cell power modules U1 to U4, V1 to V4, and W1 to W4, the control apparatus 20 implements electric power control corresponding to electric motor control by controlling the aggregate of the single-phase inverters 4B on the power source side using the cell controller 30. More specifically, at a time of acceleration or a constant speed of the electric motor 7, the control apparatus 20 extracts electric power from the power source to supply electric power while adjusting so as to maintain a direct-current voltage that is supplied to the cell power modules U1 to U4, V1 to V4, and W1 to W4 at a target value, and at a time of deceleration of the electric motor 7, the control apparatus 20 implements control that returns to the power source side a deceleration power that returns from the electric motor 7.

The control apparatus 20 detects a voltage and current of three-phase alternating current on the power source side of the power converter 1 for the purpose of electric power control on the power source side and overcurrent and overload protection, and also detects a current on the electric motor 7 side of the power converter 1 for the purpose of overcurrent and overload protection.

The contents of control at the control apparatus 20 will now be described. The control apparatus 20 decides a command value for the alternating current on the power source side based on a set target value (direct-current voltage command) and a direct-current voltage (mean value of each cell) of the cell power module that is detected. In this case, the control apparatus 20 decides the command value of the alternating current on the power source side so that an overcurrent and overload do not occur, based on the voltage and current of the three-phase alternating current that are detected on the power source side of the power converter 1. Based on the command value of the alternating current on the power source side that is decided, a voltage command is output to the U-phase, the V-phase, and the W-phase, respectively. By means of the voltage command, the cell controller 30 drives the IGBT elements Ta1, Ta2, Tb1, and Tb2 of the single-phase inverter 4B on the power source side in the cell power modules U1 to U4, V1 to V4, and W1 to W4.

Further, upon receiving a command (frequency command) from a higher order control apparatus, the control apparatus 20 sets acceleration/deceleration of the electric motor 7. At this time, the amount of change in a frequency that is required to obtain a specified target frequency is restricted so as to be within a predetermined range. This is because generation of a sharp change in frequency will cause the occurrence of an overcurrent or the like. Thus, the frequency is decided by setting the acceleration/deceleration of the electric motor 7, and the voltage is also decided based on the correlation between the frequency that is previously set and the voltage (so-called V/f control). Based thereon, a voltage command is output to the U-phase, the V-phase, and the W-phase, respectively. By means of the voltage command, the cell controller 30 drives the IGBT elements Ta1, Ta2, Tb1, and Tb2 of the single-phase inverter 4A on the electric motor 7 side in the cell power modules U1 to U4, V1 to V4, and W1 to W4.

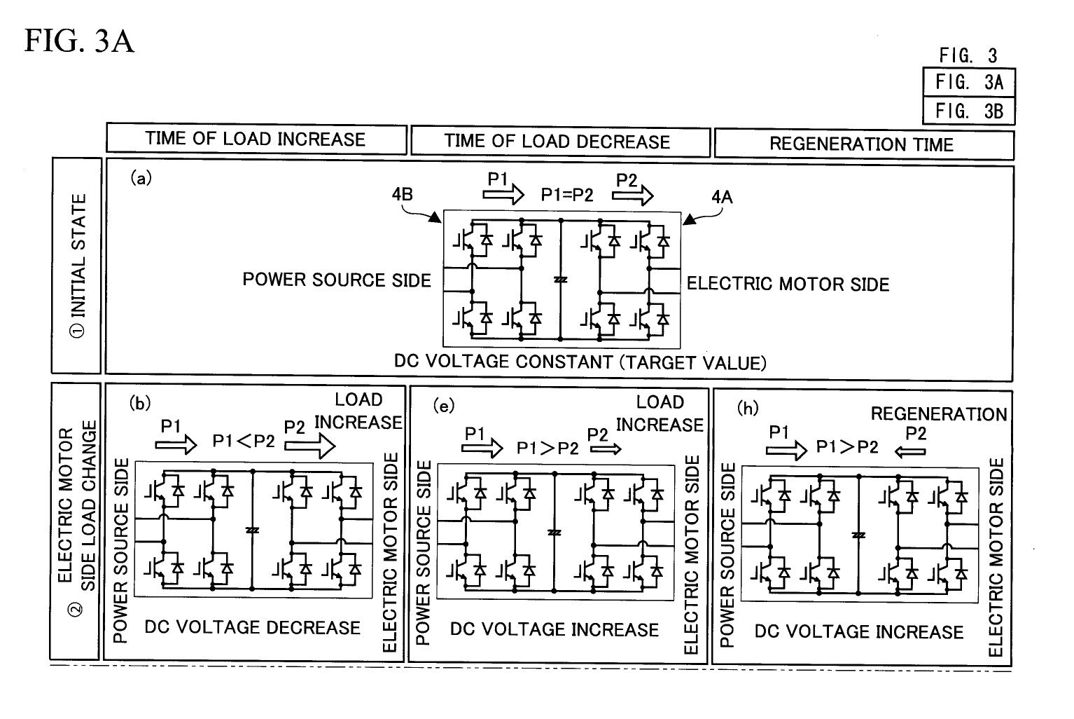

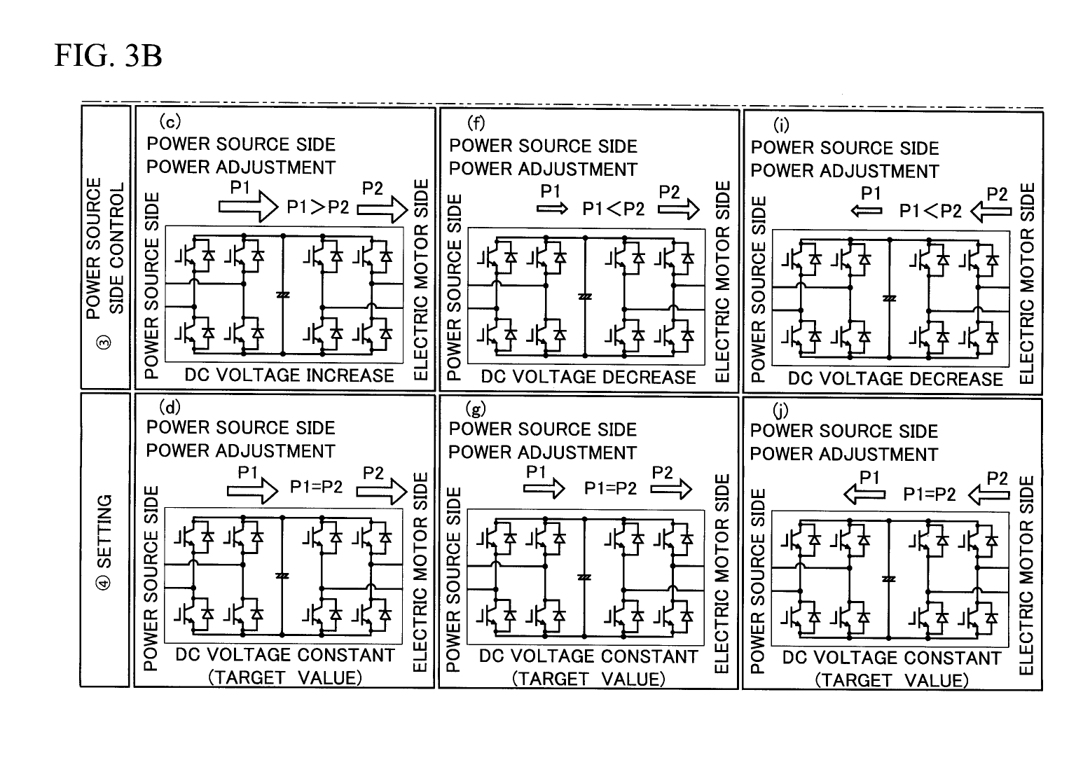

Operations according to the control of the control apparatus 20 as described above will now be described using FIG. 3.

At the power converter 1, in a case in which the load on the electric motor 7 side increases as shown in FIG. 3(b) from a state in which the electric power P1 on the power source side and the electric power P2 on the electric motor 7 side are balanced as shown in FIG. 3(a), a state is entered in which P1<P2, and as a result the direct-current voltage in each cell decreases.

Thereupon, as shown in FIG. 3(c), control is performed at the control apparatus 20 to increase the electric power P1 on the power source side so as to maintain the direct-current voltage in each cell at a target value. As a result, a state is entered in which P1>P2, and as shown in FIG. 3(d), the direct-current voltage in each cell increases as far as the target value and a state is entered in which the electric power P1 on the power source side and the electric power P2 on the electric motor 7 side are balanced.

Further, at the power converter 1, in a case in which the load on the electric motor 7 side decreases as shown in FIG. 3(e) from a state in which the electric power P1 on the power source side and the electric power P2 on the electric motor 7 side are balanced as shown in FIG. 3(a), a state is entered in which P1>P2, and as a result the direct-current voltage in each cell increases.

Thereupon, as shown in FIG. 3(f), control is performed at the control apparatus 20 to decrease the electric power P1 on the power source side so as to maintain the direct-current voltage in each cell at the target value. As a result, a state is entered in which P1<P2, and as shown in FIG. 3(g), the direct-current voltage in each cell decreases as far as the target value and a state is entered in which the electric power P1 on the power source side and the electric power P2 on the electric motor 7 side are balanced.

At the power converter 1, in a case in which power source regeneration is performed from the electric motor 7 side as shown in FIG. 3(h) from a state in which the electric power P1 on the power source side and the electric power P2 on the electric motor 7 side are balanced as shown in FIG. 3(a), a state is entered in which P1>P2 (the electric power P2 at this time is negative: regenerative direction), and as a result the direct-current voltage in each cell increases.

Thereupon, as shown in FIG. 3(i), at the control apparatus 20, the electric power P1 is reduced in the single-phase inverter 4B on the power source side, and power source regeneration is performed in a state in which P1<P2 (the electric powers P1 and P2 at this time are negative: regenerative direction). Subsequently, as shown in FIG. 3(j), a state is entered in which the electric power P1 on the power source side and the electric power P2 on the electric motor 7 side are balanced.

Thus, at the single-phase inverter 4A on the electric motor 7 side, an electric power supply that is demanded by the electric motor 7 or electric power regeneration is carried out. Meanwhile, at the single-phase inverter 4B on the power source side, control is executed to maintain the direct-current voltage in each cell at a target value.

Thus, according to the power converter 1 of the present embodiment, by providing the single-phase inverter 4B on the power source side in addition to the single-phase inverter 4A on the electric motor 7 side, it is possible to send electric power not only from the power source side to the output side, but also from the output side to the power source side, and thereby realize bidirectional power conversion in which both input and output are provided with a multicell connection. It is thereby possible to perform power source regeneration, and to make full use of a braking force.

Further, by providing isolation transformers 3 in each of the cell power modules U1 to U2, V1 to V4, and W1 to W4, it is possible to prevent interference between inverters and also prevent a short circuit occurring in a direct-current intermediate circuit. It is thereby possible to construct the bidirectional power converter 1 as described above in which both the input side and the output side are provided with a multicell connection.

Further, with regard to installation of the isolation transformers 3, the voltage of the power converter can be set to an optimal value irrespective of the voltage on the system side by changing the primary to secondary turns ratio, and a low-resistance grounding circuit can be easily provided by arrangement as a star winding as viewed from the system side.

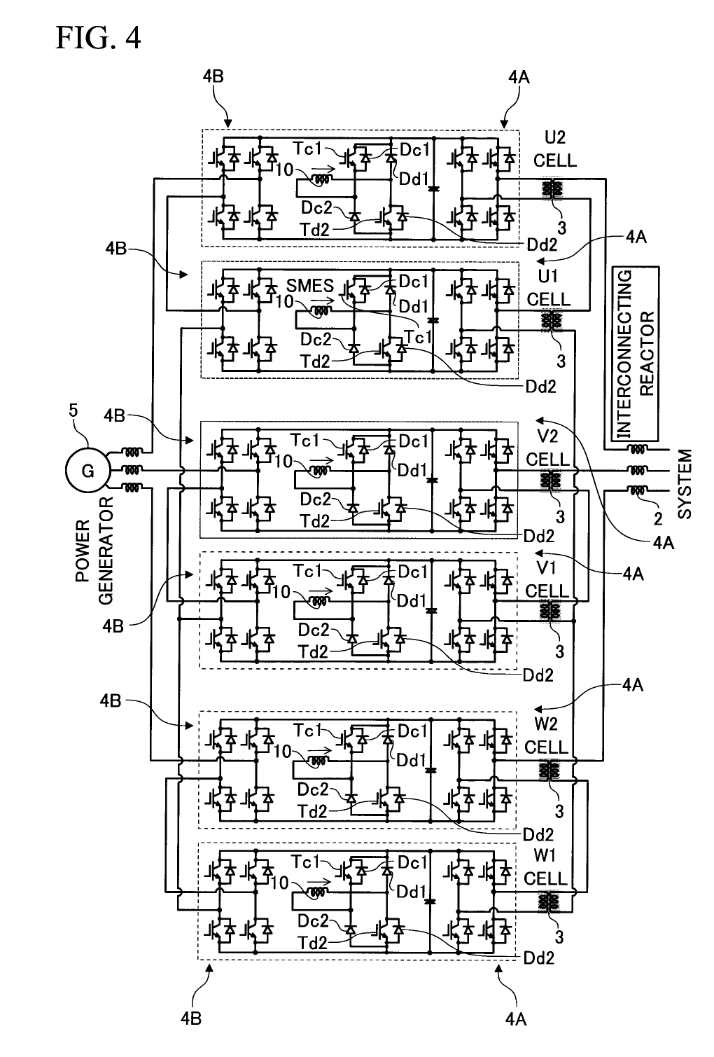

Next, a second embodiment of the present invention will be described using FIG. 4.

FIG. 4 is a block diagram that illustrates the overall configuration of a power converter according to the present embodiment. In the present embodiment, the output of a power generator (wind turbine or the like) 5 is provided to a system side, and the output of the power generator 5 and a multicell configuration (aggregate of single-phase inverters 4A and 4B of each cell power module U1 to U2, V1 to V2, and W1 to W2) are connected.

The configuration of each cell power module U1 to U2, V1 to V2, and W1 to W2 is approximately the same as the cells of the above described first embodiment, and a detailed description thereof is omitted here. However, the configuration of each cell power module according to the present embodiment differs from the first embodiment in the respect that an energy storage 10 such as a superconducting coil is connected to a direct-current section of the single-phase inverters 4A and 4B of each of the cell power modules U1 to U2, V1 to V2, and W1 to W2. A plurality of IGBTs and diodes are combined for the energy storage 10. The power converter comprises an IGBT element Tc1 to which a collector is connected on the power generator 5 side, an IGBT element Td2 to which an emitter is connected on the power generator 5 side, diodes Dc1 and Dd1 to which a cathode is connected on the power generator 5 side, and diodes Dc2 and Dd2 to which an anode is connected on the power generator 5 side. An emitter of the IGBT element Tc1, an anode of the diode Dc1, and a cathode of the diode Dc2 are connected to one terminal side of the energy storage 10, and a collector of the IGBT element Td2, an anode of the diode Dd1, and a cathode of the diode Dd2 are connected and connected to another terminal side of the energy storage 10.

Further, in consideration of isolation of the system side and voltage matching, the isolation transformers 3 that serve both isolation and voltage adjustment functions are provided on the system side.

The power generator side multicell (aggregate of single-phase inverters 4B of each cell) extracts electric power of a range that can be output even if the power generator output voltage and frequency fluctuate, and supplies the electric power to the system side multicell (aggregate of single-phase inverters 4A in each cell power module U1 to U2, V1 to V2, and W1 to W2). The system side multicell corresponds to a system frequency (50/60 Hz), and supplies electric power to the system.

The energy storage 10 of each single-phase inverter direct-current section performs charging and discharging of electric power for the purpose of smoothing output fluctuations on the power generator side.

According to the present configuration, with respect to output frequency and voltage fluctuations on the power generator side, it is possible to realize a constant frequency and voltage output to the system. Further, by installing the energy storage section 10 inside the power converter, with respect to fluctuations in the power generator output, fluctuations in the output to the system can be suppressed.

It should be noted that in the above described second embodiment, the energy storage 10 is not an essential component, and a configuration in which the energy storage 10 is omitted can also be adopted.

In this connection, although the isolation transformers 3 may be provided on either the power source system side or the power generator 5 (or electric motor 7) side according to each of the foregoing embodiments, by providing the isolation transformers 3 on the power source system side the influence of grounding conditions can be suppressed.

Further, a five-legged core three-phase transformer may be applied instead of providing a plurality of the isolation transformers 3. Thereby, it is not necessary to use a large number of the isolation transformers 3, and thus space savings and miniaturization can be achieved.

Further, by using a reactor effect of each of the aforementioned isolation transformers 3, the interconnecting reactor 2 may be omitted.

1. A three-phase power converter, wherein a cell power module comprises a set of two single-phase inverters, and N (N being an integer) units of the cell power modules are serially connected to form each phase of the three-phases; and the power converter converts and outputs an electric power that is input from a power source.

2. The power converter according to claim 1, comprising an isolation transformer between each of the cell power modules and the power source, or between each of the cell power modules and an output side.

3. The power converter according to claim 1, wherein the isolation transformer is provided between each of the cell power modules and the power source.

4. The power converter according to claim 1, wherein an electric power that is input from the power source side is subjected to power conversion by the cell power modules so that an electric motor provided on the output side is driven, and at a time that electric power is generated by the electric motor, the electric power is subjected to power conversion by the cell power modules and regenerated on the power source side.

5. The power converter according to claim 1, comprising an energy storage in a direct-current section of the single-phase inverter of the cell power module,
wherein an electric power that is input from a power generator as the power source is subjected to power conversion by the cell power module, and output fluctuations of the power generator are smoothed by charging and discharging of electric power by the energy storage.

6. The power converter according to claim 1, further comprising a control section which performs adjusting control such that:
supply of electric power demanded by the electric motor or regeneration of electric power to the power source side is carried out at the single-phase inverter on the electric motor side; and
a direct-current voltage that is supplied to the cell power module is maintained at a target value at the single-phase inverter on the power source side.
